(19) United States
(12) Patent Application Publication
(10) Pub. No.: US 2012/0088026 A1
(43) Pub. Date: Apr. 12, 2012

(54) FILM THICKNESS MEASUREMENT

(76) Inventor: John Stephen Massa, Greater Manchester (GB)

(21) Appl. No.: 13/377,945

(22) PCT Filed: Jun. 21, 2010
(86) PCT No.: PCT/GB2010/051021

§ 371 Date: Dec. 13, 2011

(30) Foreign Application Priority Data
Jun. 22, 2009 (GB) 0910736.8

(51) Int. Cl. G01B 11/06; B05C 11/00; B05C 9/12; G01J 4/00; B05D 5/00

(52) U.S. Cl. 427/9; 356/630; 356/369; 118/713

(57) ABSTRACT

A method for determining the thickness of a film on a substrate is described. The substrate has a first major surface opposite a second major surface, and the film covers a portion of the first major surface. During a first measurement step, a first measuring beam is used to determine the distance from a first reference point to a portion of the first major surface of the substrate that is not covered with the film, and a second measuring beam is used to determine the distance from a second reference point to a portion of the second major surface of the substrate that is not covered with film. During a second measurement step the first measuring beam is used to determine the distance from the first reference point to the film, and the second measuring beam is used to determine the distance from the second reference point to a portion of the second major surface of the substrate that is not covered with film. The thickness of the film so determined may be used as a control parameter in a method of applying an ink to an automotive glazing pane.

The present invention relates to a method for determining the thickness of a film on a substrate, in particular the thickness of a wet ink film on a sheet of glass.

It is well known in the automotive industry to use black obscuration bands on vehicle windows. Such obscuration bands are typically produced by applying a suitable ink to the flat glass sheet prior to the sheet being subsequently processed. The ink is usually applied to the flat glass sheet by a screen printing process, although other suitable techniques may be used, for example, ink jet printing, spraying or brushes. The flat glass sheet with wet ink on a major surface is subsequently heated to bend and/or toughen the glass sheet, whereby the ink is dried and becomes fused to the glass surface.

Depending upon the particular application, the ink used may be electrically conductive or electrically non-conductive.

In the automotive industry, electrically conductive inks are used in forming heated zones on a vehicle glazing and certain types of antenna. Such inks typically contain silver, although other conductive inks are known.

To produce a consistent product, the thickness of the ink applied to the glass surface should be measured. Whilst the thickness of the fused layer can be measured after the glass sheet has been processed, it is advantageous to measure the ink thickness soon after the ink has been applied to the glass sheet, whilst the ink is still wet. This allows a more rapid change of ink application procedures, with a benefit to production line efficiency.

In the automotive industry, a common method of measuring wet ink thickness utilises a calibrated contact wheel. The contact wheel is rolled over the ink covered glass surface, whilst the ink is still wet. The ink covers the contact wheel, allowing a reading to be made therefrom to indicate the wet ink thickness. This has the problem that the wet ink must be contacted, thereby making the part being measured unusable because of the imprint left in the ink of the wheel. As such, the test is destructive and the sample being tested cannot subsequently be used as a commercial product.

There are known apparatus and methods for measuring the thickness of a film on a substrate without directly contacting the film or the substrate. U.S. Pat. No. 4,702,931 discloses a wet film measuring device which makes a measurement of paint film thickness on an object such as a vehicle panel. Two ultrasonic transducers are used, one above and one below the painted panel. The distance from each transducer to the panel is measured and the paint film thickness is calculated. By subtracting the known panel thickness, paint film thickness is then determined. This method has the disadvantage that the panel thickness must be accurately known.

It is known to use a single confocal chromatic displacement sensor to measure the thickness of films on ceramic substrates, substrate warp and print stretch, even on freshly printed paste. If only one sensor is used to measure the profile of the surface from above, a stable support that is free from vibration is needed in order to avoid incorrectly measuring the surface topology. Such stable supports, usually taking the form of a slab of dense material such as granite, are useful for small sample sizes i.e. silicon chip wafers, but are not useful when the sample size is large, as is the case in automotive glazings.

Another system is described at the following internet link, http://www.aspe.net/publications/Annual_{—}2005/PAPERS/4METRO/1761.PDF. The method of thickness measurement described therein relies on measuring the thickness of a stepped reference sample of known thickness. Such a method is time consuming because in addition to the sample thickness being measured, the thickness of the reference sample must also be made.

In U.S. Pat. No. 5,661,250 a method of measuring the thicknesses of each layer coated on both surfaces of a base material is disclosed. The method requires the vertical separation of two displacement sensors to be accurately known. In addition, the thickness of the base material is required to calculate the thickness of one of the coating layers. The thickness of the base material is measured using a separate measurement step, thereby increasing the number of calculation steps and time required to make a thickness measurement of the coating layers.

The present invention aims to overcome the problems of these known methods.

Accordingly the present invention provides from a first aspect a method for determining the thickness of a film on a substrate, the substrate having a substantially constant thickness and having a first major surface and an opposed second major surface, wherein the film covers a portion of the first major surface, the method comprising the steps of positioning a first sensor relative to the substrate, arranged to direct a first measuring beam onto the first major surface of the substrate; positioning a second sensor relative to the substrate, arranged to direct a second measuring beam onto the second major surface of the substrate, and a first measurement step and a second measurement step, the first measurement step comprising using the first measuring beam to determine the distance from a first reference point to a portion of the first major surface of the substrate that is not covered with the film; and using the second measuring beam to determine the distance from a second reference point to a portion of the second major surface of the substrate that is not covered with film; and the second measurement step comprising using the first measuring beam to determine the distance from the first reference point to the film, and using the second measuring beam to determine the distance from the second reference point to a portion of the second major surface of the substrate that is not covered with film.

The second measurement step may precede the first measurement step.

Methods according to the present invention have the advantage that the thickness of the substrate does not need to be measured or predetermined, which improves the measurement speed. By assuming that the substrate has substantially constant thickness, the methods according to the present invention are less susceptible to vibration, tilt and curvature of the substrate during the first and second measurement steps. Methods in accordance with the present invention may be used to determine the thickness of a wet film on a substrate, and the sample being measured may subsequently be used to produce a commercial product. Such methods also have the advantage that the thickness determination is non-destructive because there is no physical contact with the film.

It is to be understood within the context of the present invention, that the “substrate” may comprise two layers, for example a flat glass sheet having a coating that covers one of the major surfaces of the glass sheet. Alternatively, the substrate may be a bilayer construction, for example consisting of a sheet of glass bonded to a sheet of a plastic material. The substrate may have major surfaces that are not chemically or physically identical i.e. they may have a difference chemical composition and/or morphology.

It is also to be understood within the context of the present invention that “substantially constant thickness” means that the variation in thickness of the substrate over the measurement region is less than the required measurement accuracy of the film thickness. For example, if it is required to measure the thickness of the film on the substrate to an accuracy of ±1 μm, the variation of the substrate thickness over the measurement region should be less than ±1 μm. Likewise, if the variation of the substrate thickness is ±10 μm over the scan region, then the resolution of the film thickness measurement will be worse, being at best ±10 μm. In both these examples, within the context of the present invention, the substrate has a substantially constant thickness.

Preferably, during the first measurement step, the first sensor is opposite the second sensor such that the first measuring beam is opposite the second measuring beam. The first measuring beam may be in registration with the second measuring beam. This has the advantage that the first measurement step has less susceptibility to substrate vibration, tilt or curvature during the first measurement step. In a preferred embodiment, the first measuring beam is suitably displaced relative to the second measuring beam, which may be achieved by suitably displacing the first sensor relative to the second sensor, or by a suitable sensor design. This has the advantage that the first measuring beam does not interfere with the measurement made by the second sensor and that the second measuring beam does not interfere with the measurement made by the first sensor. Preferably the first sensor is laterally displaced with respect to the first sensor.

In other preferred embodiments, during the second measurement step, the second sensor is opposite to the first sensor such that the second measuring beam is opposite the first measuring beam. Preferably the first sensor is laterally displaced with respect to the second sensor.

In other embodiments, preferably the first measuring beam has a different polarization to the second measuring beam. This has the advantage that the first sensor can be tuned to detect only that polarisation that corresponds to the first beam and the second sensor can be tuned to detect only that polarisation that corresponds to the second beam, thereby reducing possible interference. Suitably the first measuring beam and the second measuring beam are orthogonally polarised.

Preferably the first sensor scans across the first major surface. This allows a continuous measurement to be made.

Preferably the second sensor scans across the second major surface in registration with the first sensor scanning across the first major surface. This has the advantage that the method is less susceptible to vibration/tilt/curvature of the sample when being measured, because the sensors measure opposite points of the substrate simultaneously.

Preferably the first measuring beam and/or the second measuring beam is polychromatic.

Preferably the first and/or second sensor is a chromatic displacement sensor, in particular a confocal chromatic displacement sensor.

Preferably the first reference point is associated with the first sensor. This has the advantage that the first reference point moves with the first sensor, thereby allowing a more rapid measurement to be made.

Preferably the second reference point is associated with the second sensor. This has the advantage that the second reference point moves with the second sensor, thereby allowing a more rapid measurement to be made.

Preferably the separation of the first sensor relative to the second sensor is the same, or substantially the same during the first measurement step and the second measurement step.

Suitably the first sensor is not displaced relative to the second sensor during the first measurement step and the second measuring step.

Preferably the first sensor is in mechanical communication with the second sensor.

Methods according to the present invention are particularly suited to the measurement of the thickness of a wet film on a substrate, such as a wet ink on a glass sheet.

Preferably the substrate is substantially flat, although the method may be used with curved substrates having a substantially constant substrate thickness. Preferably the substrate is an automotive glazing pane, for example comprising a pane of glass or plastic material. The automotive glazing pane may be subsequently processed.

Suitably the first measuring beam strikes the first major surface at normal, or substantially normal incidence.

Suitably the second measuring beam strikes the second major surface at normal, or substantially normal incidence.

When the first measuring beam and the second measuring beam are arranged such that the first measuring beam and the second measuring beam strike the respective major surface at normal, or substantially normal incidence, the film thickness may be determined by a film thickness calculation step comprising a first calculation step, wherein a first distance is calculated by subtracting the distance determined using the first measuring beam during the second measurement step from the distance determined by the first measuring beam during the first measuring step, and a second calculation step wherein a second distance is calculated by subtracting the distance determined using the second measuring beam during the second measurement step from the distance determined by the second measuring beam during the first measurement step, and a third calculation step wherein the film thickness is determined by adding the first distance calculated during the first calculation step to the second distance calculated during the second calculation step.

From a second aspect, the present invention provides a method of applying an ink to an automotive glazing pane comprising the steps of arranging an ink application device relative to a major surface of the glazing pane; applying the ink to a portion of a major surface of the glazing pane; determining the thickness of the ink using a method according to the first aspect of the invention; and using the thickness of the ink so determined as a control parameter to control the amount of ink subsequently applied to the glazing pane or a subsequent glazing pane.

From a third aspect, the present invention provides an apparatus for applying ink to an automotive glazing pane comprising an ink application device for applying ink to a surface of the glazing pane; a support for the glazing pane; a first chromatic displacement sensor opposite a second chromatic displacement measurement sensor, sufficiently spaced to accommodate the pane thickness; means for moving the glazing pane relative to the first chromatic displacement sensor; and control means in electrical communication with the ink application device and the first and/or second chromatic displacement sensors, configured to control the amount of ink applied to the surface of the glazing pane.

Embodiments of the present invention will now be described by way of example only with reference to the following figures (not to scale) in which,

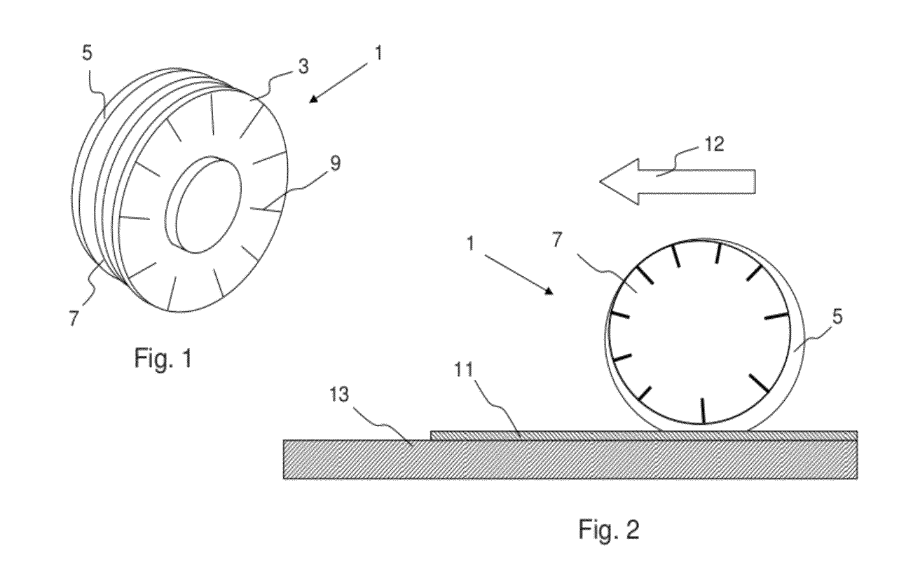

FIG. 1 shows a perspective view of a wheel used to measure the thickness of wet ink on a flat glass sheet;

FIG. 2 shows a side view of the wheel in FIG. 1 when being used to measure the thickness of a wet ink film on a flat glass sheet;

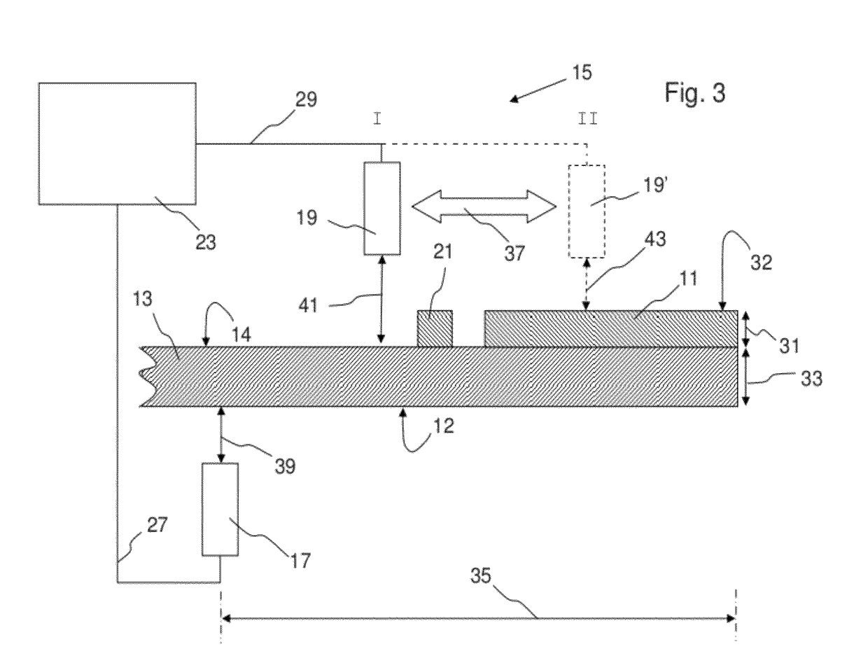

FIG. 3 shows a schematic of an apparatus for carrying out a method to determine the thickness of a wet ink film on a flat glass sheet;

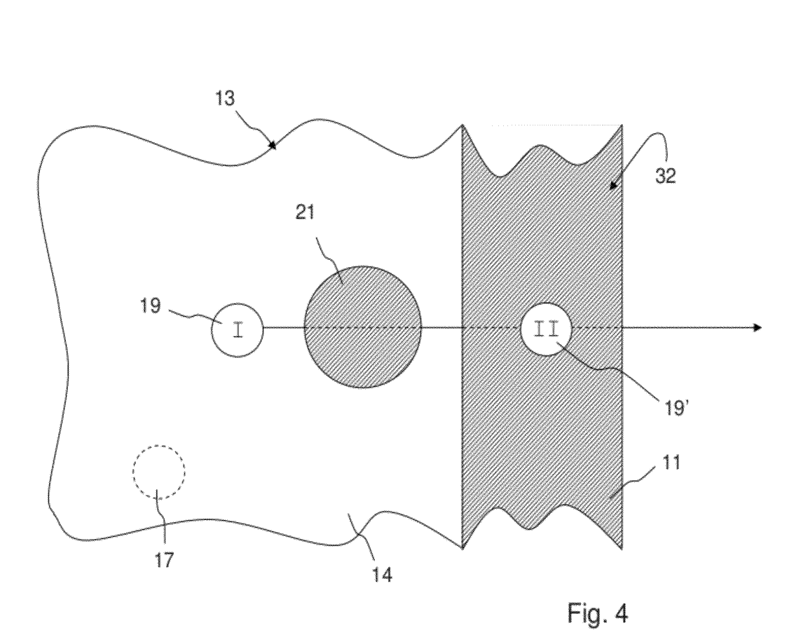

FIG. 4 shows a plan view of a glazing having two wet ink regions on the upper major surface of a flat glass sheet;

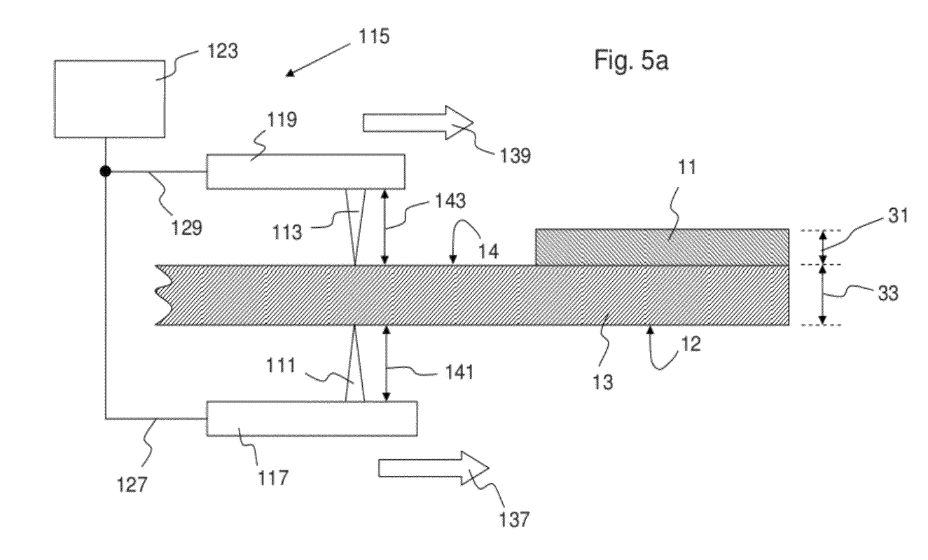

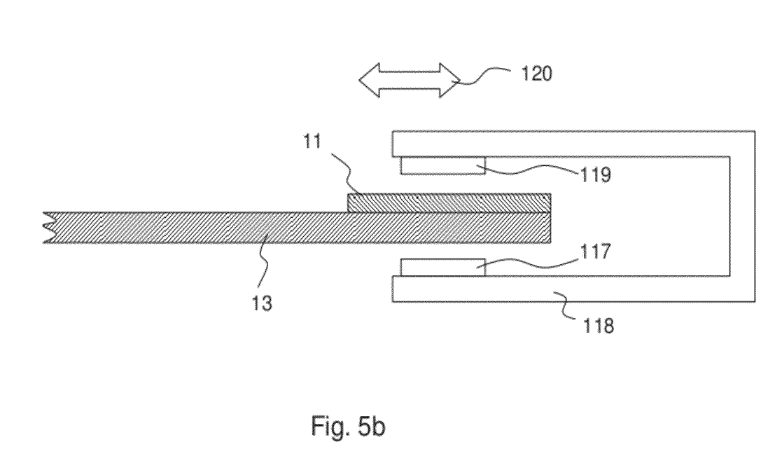

FIG. 5a shows another schematic of an apparatus for carrying out another method in accordance with the present invention, the apparatus being in a first configuration;

FIG. 5b shows one particular way of mounting the first sensor relative to the second sensor;

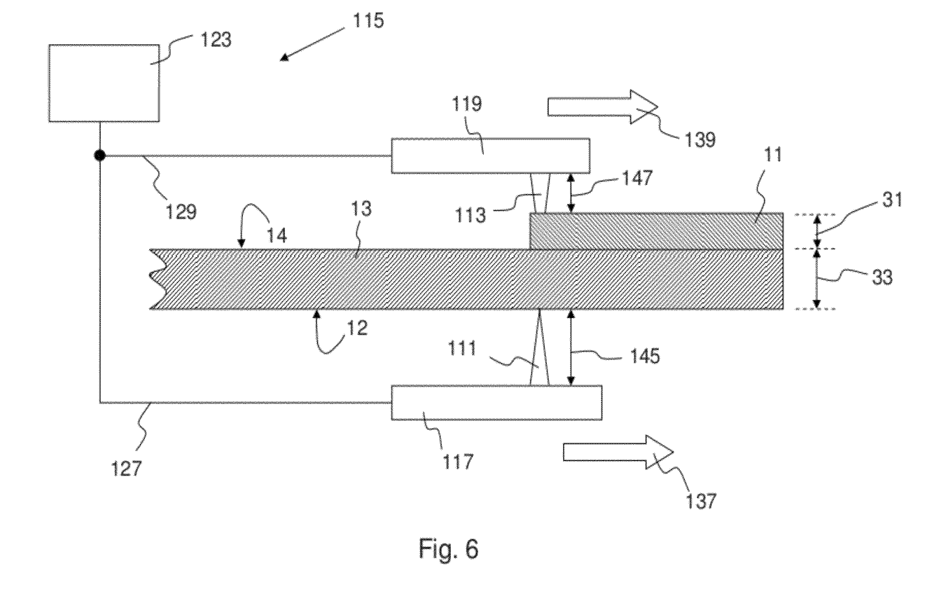

FIG. 6 shows the apparatus shown in FIG. 5a in a second configuration;

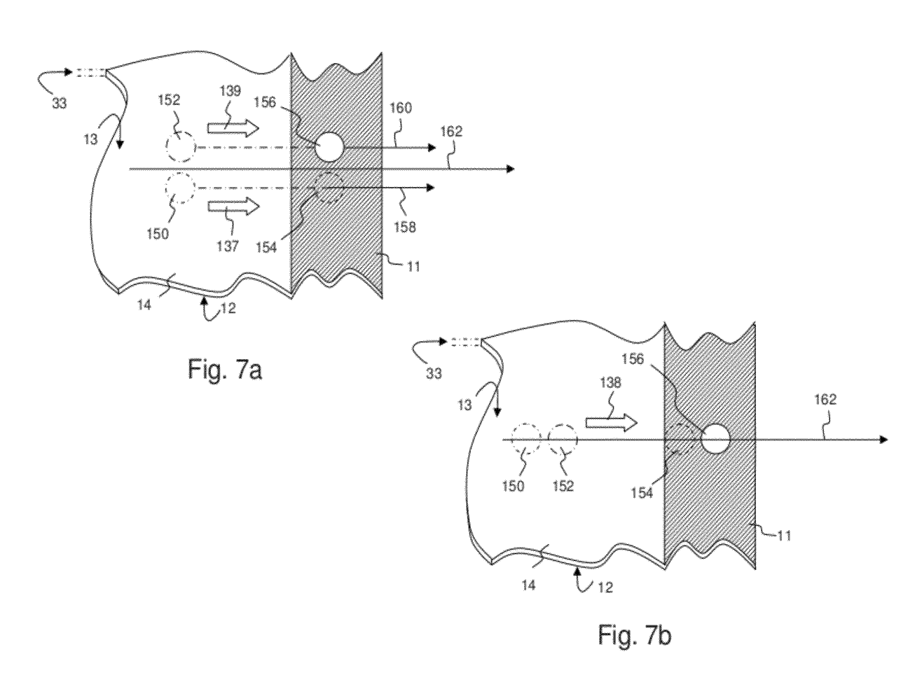

FIGS. 7a and 7b show schematic plan views of the glass sheet shown in FIGS. 5a and 6;

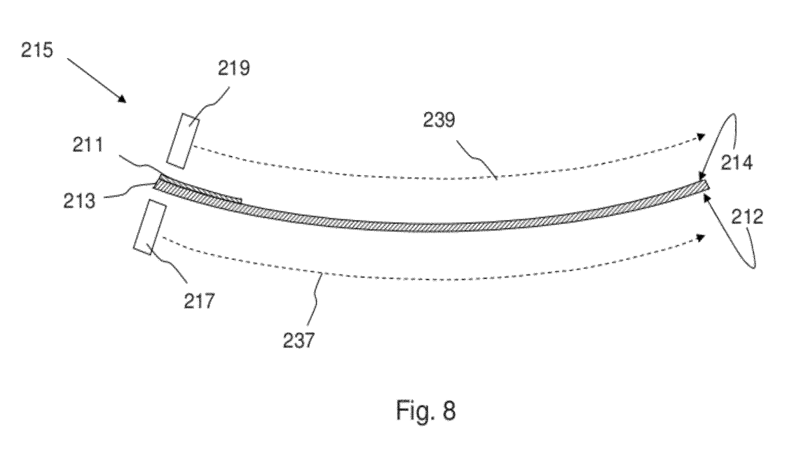

FIG. 8 shows a schematic of another apparatus for measuring the thickness of a wet ink film on a curved glass sheet;

FIG. 9 shows a plan view of a portion of a windscreen blank having a freshly printed obscuration band on a major surface of the windscreen blank, prior to the blank being processed; and

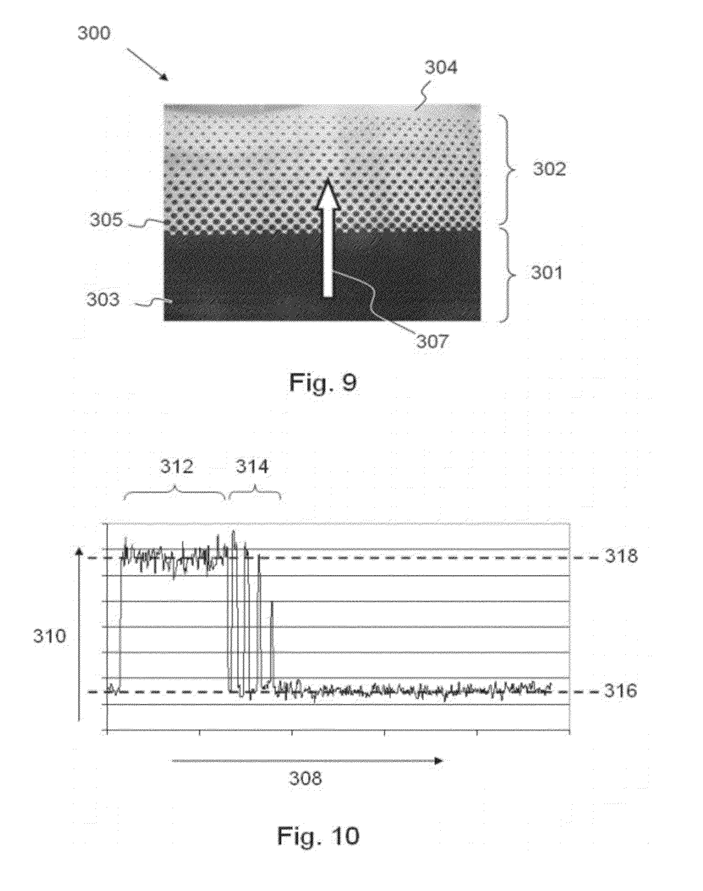

FIG. 10 shows a typical output trace for determining the thickness of a wet ink film on a sheet of glass, as in FIG. 9.

FIG. 1 shows a perspective view of a wheel used to measure wet ink thickness on flat glass substrates in a manner known to one skilled in the art. The wheel 1 consists of three metal discs, two outer discs 3, 5 and an inner disc 7. The outer discs 3, 5 are concentric and have the same outer diameter. The inner disc is smaller and positioned eccentrically relative to the outer discs 3, 5. The outer diameter of the inner disc 7 is coincident at one point with the outer diameter of the two outer discs. There is a calibration scale 9 on the outer disc 3.

With reference to FIG. 2, the wheel is used as follows to determine the thickness of a wet ink film 11 on a flat glass sheet 13. Firstly, the wheel is placed onto the glass sheet 13 so that the wheel 1 contacts the wet ink film 11. The wheel is then rolled in the direction of the arrow 12. As the wheel is rolled through the wet ink film, the inner disc 7 will eventually contact the wet ink film. The first point of contact of the inner disc with the wet ink film can then be read off the calibrated scale 9 on the side of the wheel. For clarity, FIG. 2 shows a cross section through the wheel and the inner disc 7 is shown with a calibration scale.

This method has the disadvantage that the sample being measured cannot be used as a commercially acceptable product because as the wheel rotates in the wet ink, the quality of the film there is disturbed. This is a destructive test. Additionally, when using the wheel, the wet film thickness at only one point on the wet ink film is measured.

FIG. 3 shows a schematic of an apparatus 15 for practising a method according to the first aspect of the present invention. The apparatus 15 comprises a first confocal chromatic displacement sensor 17 positioned below the lower major surface 12 of glass sheet 13. Positioned above the upper major surface 14 of the glass sheet 13 is a second confocal chromatic displacement sensor 19.

A confocal chromatic displacement sensor is designed to have a specific measuring range, MR. The start of the measuring range, SMR, is also fixed by design. The SMR is usually defined as the distance from the aperture in the sensor head from which the measuring beam emerges to the beginning of the MR. It is possible to determine the distance from the sensor to an object, provided that the object is within the MR. Confocal chromatic displacement sensors also have an associated measurement beam spot diameter SD and a measurement reproducibility Δmr. Confocal chromatic displacement sensors having specific combinations of MR, SMR, SD and Δmr are commercially available. The appropriate type of confocal chromatic displacement sensor is chosen to suit the particular application.

Each confocal chromatic displacement sensor emits a measuring beam consisting of polychromatic light towards the respective surface. Each measuring beam strikes the respective surface at a normal, or substantially normal, angle of incidence. The sensors 17, 19 are configured to measure the distance relative to a point on the respective sensor of an object within 2 mm of the sensor head. The measurement is made to within a reproducibility of ±1.5 μm.

There is a wet ink film 11 covering a portion of the upper major surface 14 of the glass sheet 13. There is also a smaller portion of the upper major surface of the glass sheet 13 covered with a film of wet ink 21. The wet ink film 21 may be a dot on the upper major surface 14 of the glass sheet 13. To the left of the wet ink film 21, the upper major surface 14 of the glass sheet 13 is free from ink The lower major surface 12 of the glass sheet 13 is free from ink There may be a portion of the lower major surface of the glass sheet covered with another wet ink film. In such an instance, the thickness of the wet ink film on a respective surface is measured by reference to a point on the opposing surface that is free from ink.

Each sensor 17, 19 is in electrical communication via respective cables 27, 29 with an apparatus 23 for converting the output from the sensors 17, 19 into a distance measurement. The apparatus 23 comprises a computer (not shown). The apparatus 23 may comprise control means to control the amount of ink applied to subsequent glass sheets via a suitable ink deposition apparatus.

In this particular embodiment, sensor 17 is arranged to be static with respect to the glass sheet. Sensor 17 is therefore arranged to make measurements at substantially the same point on the lower major surface of the glass sheet. Sensor 19 is mounted on a movable stage, arranged to move the sensor 19 in the direction of arrow 37 relative to the glass sheet. The sensor 19 is able to scan the upper major surface of the glass sheet, in a direction towards the edge of the glass sheet (and back again if required). The movable stage may be configured to move the sensor 19 across the entire upper major surface 14 i.e. in two or more directions.

The thickness of the wet ink film 11, 21 is denoted by arrow 31 and the thickness of the glass sheet 13 is denoted by the arrow 33. The glass sheet 13 has substantially constant thickness over the measurement region 35. For glass produced by a float process, the thickness is substantially constant over sheets having dimensions of 3 m by 4 m. The thickness variation of glass produced by a float process is usually less in the direction of draw than across the ribbon width. The direction of draw is the direction in which the glass ribbon travels when the molten glass leaves the tin bath.

The wet ink thickness 31 is measured as follows. The sensor 17 measures the distance 39 from the sensor 17 to the lower major surface 12 of the glass sheet. The sensor 19, at position I, measures the distance 41 from the first sensor to the upper major surface 14 of the glass sheet. The distance 39 measured by sensor 17 when sensor 19 is at position I shall be referred to as 39(I).

The sensor 19 then scans across the upper major surface of the glass sheet, making distance measurements from the sensor 19 to the first incident upper surface (glass or ink) along the scan line. For example, when the sensor 19 is located above the wet ink film 11 (shown in phantom at position II and designated as 19′), the sensor 19′ measures the distance 43 from the sensor 19′ to the upper surface 32 of the wet ink film 11.

When the distance 43 is measured by sensor 19′ at position II, the sensor 17 makes another measurement of the distance 39. This distance shall be referred to as 39(II).

The vertical separation of sensor 17 from sensor 19 is the same at positions I and II.

By assuming that the glass sheet 13 has substantially constant thickness across the measurement region, then the thickness 31 of the wet ink film at the particular measurement point of sensor 19 can be determined using the following:

At position I

Distance 39(I)+Glass Thickness 33+Distance 41=k (1)

At position II

Distance 39(II)+Glass Thickness 33+Film Thickness 31+Distance 43=k (2)

where k is a constant.

When k is constant, the film thickness 31 is obtained as follows.

By subtracting (1) from (2), the following equation (3) is obtained because the distance of each sensor from the respective major surface at both measuring positions is substantially the same (equivalent to the vertical spacing of the two sensors being substantially the same at both measuring positions), and it is assumed that the glass thickness is constant,

Film Thickness 31=[Distance 39(I)−Distance 39(II)]+[Distance 41−Distance 43] (3)

Equation (3) above shows that by assuming the glass thickness is constant, the glass thickness need not be measured as it appears in both equations (1) and (2). Additionally, by ensuring that sensor 17 remains a fixed distance away from the lower major surface and that sensor 19 remains a fixed distance away from the upper major surface (equivalent the vertical spacing of the two sensors being the same, or substantially the same at both measuring positions), constant k is the same in equations (1) and (2).

It should be noted that k is a constant when the vertical separation of the two sensors 17, 19 remains constant. When this is the case, k is the actual vertical separation of the two sensors. It is possible that k may vary, for example by providing a look up table of k values for each measuring position. The simplest arrangement is when k is constant, and hence the vertical separation of the sensors is constant i.e. the same, or substantially the same, at both measuring positions. Slight variation in the vertical separation of the two sensors is possible, for example due to thermal fluctuations, providing the variation in the spacing of the two sensors is less than the desired measurement accuracy. Advantageously the two sensors 17, 19 are in mechanical communication to reduce the effect of such variations.

In equation (3), the left hand term in square brackets is the difference in the sensor 17 reading between the measurement at I and the measurement at II. The right hand term in equation (3) is the difference in the sensor 19 reading between measurement at I and II.

If between subsequent measurements the glass sheet vibrates, or the glass sheets is tilted or curved, because of the assumption that the glass sheet is of substantially the same thickness, then any effect due to vibration/tilt/curvature on the measurement of distance 43 will be equal and opposite in the measurement of distance 39. For example, if the sample moves upwards by a distance Ad, the distance measured by the upper sensor will be reduced by an amount Δd and the distance measured by the lower sensor will be increased by an amount Δd. As a result, these effects cancel each other out and there is no effect on the measurement of film thickness 31.

In principle only one distance measurement needs be made by the sensor 17, however such an operation of apparatus 15 will be more susceptible to slight curvature of the substrate and any vibrations in the substrate when the distance measurements are made.

A plan view of part of the glass sheet shown in FIG. 3 is illustrated in FIG. 4. The glass sheet 13 has an upper major surface 14. As this figure shows, a portion of the upper major surface of the glass sheet is covered with a wet ink film 21 in the form of a dot. There is a second portion of the upper major surface 14 that is also covered with a wet ink film 11. The wet ink film 11 extends to the periphery of the glass sheet 13.

The confocal chromatic sensor 17 (shown in phantom) is located beneath the lower major surface of the glass sheet 13. Confocal sensor 19 is located above the upper major surface of the glass sheet 13. In the position I, the sensor 19 measures the distance between the sensor 19 and upper major surface 14. At position II, the sensor 19 has moved to the position 19′ and is located above the wet ink film 11. At this measurement position II, the sensor 19 measures the distance between the sensor 19 and upper surface of the wet ink film 11.

At each measurement position I, II, the lower sensor 17 records the distance between the lower surface and the sensor 17. Alternatively, this measurement may be made at another time, and the value recorded for subsequent use. For improved accuracy, the sensor 17 makes a measurement at the same time, or substantially the same time, as the measurement made by the upper sensor 19. By making synchronous or substantially synchronous distance measurements with the sensors 17, 19, effects of vibration of the glass sheet on the wet ink film thickness measurement are reduced.

FIG. 5a shows another apparatus 115 for practising another method in accordance with the present invention. The apparatus is used to determine the thickness 31 of a wet ink film 11 deposited on the upper major surface 14 of glass sheet 13. The glass sheet has a substantially constant thickness 33 across the entire sheet.

The apparatus 115 comprises a lower confocal chromatic displacement sensor 117 located beneath the glass sheet 13. The sensor 117 is arranged to direct a measuring beam 111 onto the lower major surface 12 of the glass sheet 13. The apparatus also comprises an upper confocal chromatic displacement sensor 119 arranged to direct a measuring beam 113 onto the upper major surface 14 of the glass sheet 13. Each measuring beam strikes the respective surface at a normal, or substantially normal, angle of incidence.

Each sensor 117, 119 is in electrical communication via respective cables 127, 129 with an apparatus 123. The apparatus 123 is configured to convert the output from the sensors into distance measurements. The apparatus 123 comprises a computer (not shown). The apparatus 123 may comprise control means to control the amount of ink applied to subsequent glass sheets via a suitable ink deposition apparatus.

Each sensor 117, 119 is mounted on a movable stage (not shown) so that each sensor 117, 119 can scan across the respective major surface. The sensor 117 scans across the lower major surface 12 in the direction of arrow 137 and the sensor 119 scans across the upper major surface 14 in the direction of arrow 139. The movable stage is configured such that the two sensors move at the same scan rate and in the same direction at the same time. Whilst it is possible that the two measuring beams 111, 113 are in registration, for a transparent substrate such as a glass sheet, the measuring beam 111 may pass through the substrate and interfere with measurements made by sensor 119. Likewise, the measuring beam 113 may pass through the substrate and interfere with measurements made by sensor 117. To reduce such interference effects, the sensors may be configured such that the measuring beams 111, 113 are offset from one another by a sufficient amount such that aforementioned interference does not occur. Alternatively, each measuring beam 111, 113 may have a different plane of polarisation, for example the measuring beam 111 may be orthogonally polarised with respect to the measuring beam 113. Suitable polarizing filters may be incorporated into the sensor so that the sensor only receives a correctly polarized beam, thereby reducing the aforementioned interference effects.

In the configuration shown in FIG. 5a, the lower sensor 117 measures the distance 141 from the sensor 117 to the lower major surface 12. The upper sensor 119 measures the distance 143 from the sensor 119 to the upper major surface 14.

The movable stage (not shown) is configured such that the sensors 117, 119 are a fixed distance apart. Since the glass sheet is planar, each sensor is a fixed distance away from the respective major surface of the glass sheet.

The sensors may be movable independently of each other, in which case each sensor has a movable stage associated therewith.

Preferably the movable stage is configured such the first sensor is in mechanical communication with the second sensor. With such a configuration, the effect of any vibration of the movable stage is reduced because each sensor vibrates together. A suitable movable stage comprises a ‘C’-frame and an example is shown in FIG. 5b. Each sensor 117, 119 is in mechanical communication via the ‘C’-frame 118 i.e. the first sensor is mechanically connected to the second sensor. The ‘C’-frame is movable in the direction of arrow 120. The ‘C’-frame ensures that the sensors 117, 119 remain a fixed distance apart. Additionally, by using a ‘C’-frame the sensors may be moved in from the edge of the glass sheet towards the central region and allows the entire peripheral region of the glass sheet to be scanned by suitably moving the ‘C’-frame relative to the glass sheet. This is particularly useful when the glass sheet is an automotive glazing with an obscuration band around the peripheral region thereof.

FIG. 6 shows the apparatus 115 of FIG. 5a in a second configuration for determining the thickness 31 of the wet film 11. The sensors 117, 119 have been moved at the same time along a scan line, such that the sensor 117 is beneath the portion of the glass sheet that has wet ink film 11 on the upper major surface of the glass sheet. Sensor 119 is above the wet ink film.

Sensor 117 measures the distance 145 from the sensor 117 to the lower major surface 12. Sensor 119 measures the distance 147 from the sensor 119 to the upper surface of the wet ink film 11.

The thickness profile of the entire wet ink film 11 may be determined by scanning the sensors 117, 119 across the respective major surface in the direction of arrows 137 and 139 respectively.

FIG. 7a shows a plan view of a glass sheet 13 and indicates schematically the positions of the measuring beams in FIGS. 5a and 6. With reference to FIGS. 5a and 6, the region 150 represents the portion of the lower major surface 12 upon which the measuring beam 111 is incident when distance 141 is determined. The region 152 represents the portion of the upper major surface 14 upon which the measuring beam 113 is incident when distance 143 is determined. The measurement regions 150 and 152 are laterally displaced.

The scan line is represented by line 162. By moving the upper and lower sensors (not shown) in the direction of arrows 137, 139, the thickness profile of the wet ink film on the upper major surface of the glass sheet 13 can be determined.

The region of the lower major surface upon which the measuring beam 111 is incident follows scan line 158. The region of the upper major surface upon which the measuring beam 113 is incident follows the scan line 160. Scan lines 158, 160 and 162 are parallel. The regions 150, 152 scan across the respective surface at substantially the same speed.

The region 154 represents the portion of the lower major surface 12 upon which the measuring beam 111 is incident when distance 145 is determined. The region 154 is free of ink The region 156 represents the portion of the surface of the wet ink film upon which the measuring beam 113 is incident when distance 147 is determined.

Since the movement of the upper and lower sensors is synchronised, the movement of the measuring beams 111, 113 is also synchronised.

An alternative embodiment is shown in FIG. 7b. FIG. 7b shows a plan view of a glass sheet 13 and indicates schematically the positions of the measuring beams in FIGS. 5a and 6. With reference to FIGS. 5a and 6, the region 150 represents the portion of the lower major surface 12 upon which the measuring beam 111 is incident when distance 141 is determined. The region 152 represents the portion of the upper major surface 14 upon which the measuring beam 113 is incident when distance 143 is determined. The measurement region 150 lags behind the measurement region 152, suitably by 1-2 mm.

The scan line is represented by line 162. By moving the upper and lower sensors (not shown) in the direction of arrow 138, the thickness profile of the wet ink film can be determined.

Both the regions 150, 152 follow the scan line 162. The regions 150, 152 scan across the respective surface at the same, or substantially the same speed.

The region 154 represents the portion of the lower major surface 12 upon which the measuring beam 111 is incident when distance 145 is determined. The region 156 represents the portion of the surface of the wet ink film upon which the measuring beam 113 is incident when distance 147 is determined.

Since the movement of the upper and lower sensors is synchronised, the movement of the measuring beams 111, 113 is also synchronised.

By using a pair of opposed sensors, suitably configured such that there is little interference between the measuring beam of the upper sensor with the measuring characteristics of the lower sensor, and vice versa, the effects of sample vibration, curvature and tilt are reduced because of simultaneous upper and lower distance measurements are made along the scan line. This will be illustrated further below.

With reference to FIGS. 5a and 6, the thickness 31 of the wet ink film 11 is determined as follows.

Distance 141+Glass Thickness 33+Distance 143=k (4)

Distance 145+Glass Thickness 33+Film Thickness 31+Distance 147=k (5)

where k is a constant because the two sensors are a fixed distance apart i.e. the vertical separation of the sensor 117 relative to sensor 119 is the same, or substantially the same at both measuring positions.

Subtracting equation (4) from equation (5), the following is obtained (assuming the glass thickness 33 is constant) because the separation of the sensors at both measuring positions is substantially constant,

Film Thickness 31=(Distance 141−Distance 145)+(Distance 143−Distance 147) (6)

By using an upper and lower sensor, arranged to make synchronised distance measurements between the sensor and respective surface, any vibrations are effectively cancelled out, because at each measurement point, if the upper distance measurement varies by an amount +Δd, there is a corresponding variation in the lower distance measurement of −Δd.

In addition, if there is a slight curvature in the substrate, as can happen when a flat substrate is placed on a nominally flat surface, the use of upper and lower sensors positioned substantially opposite each other removes the effect of such curvature. Due to the manner of operation of confocal displacement sensors, a distance measurement is only possible using such sensors if the object is within the MR. If the sample being measured has a curvature such that the sample extends outside of MR during the length of the scan, then a distance measurement will not be possible for the parts of the sample that are not within the MR.

It is important when the upper and lower distance measurements are made that the distance is made in relation to a known reference point. One such way of achieving this is to fix the distance between the sensor and the glass sheet, in which case, the reference point for each sensor can be the sensor itself, or a point on the sensor. This is equivalent to the sensors being a fixed distance apart at both measuring positions. However, it is possible that the distance between the sensors and the respective major surface may vary. This is equivalent to the sensors not being a fixed distance apart. For such a situation, a look up table of k values for each measurement point may be provided.

FIG. 8 illustrates another apparatus 215 configured to carry out another method in accordance with the present invention.

The apparatus is configured to determine the thickness of a wet ink film 211 covering a portion of the upper major surface 214 of curved glass sheet 213.

The apparatus comprises a lower confocal chromatic displacement sensor 217 positioned below the lower major surface 212 of the curved glass sheet 213. Opposite the lower sensor, and positioned above the upper major surface 214 of the curved glass sheet is another confocal chromatic displacement sensor 219. Sensor 217 is arranged to direct a measuring beam onto the lower major surface of the glass sheet and sensor 219 is arranged to direct a measuring beam onto the upper major surface of the glass (or the upper surface of the wet ink ink).

The sensors are mounted on a suitable movable stage such that sensor 217 follows curved path 237 and sensor 219 follows curved path 239. The sensors move together at the same speed. The sensors are arranged such that the measurement beams are laterally displaced.

The paths 237, 239 each define reference points with which the sensor measures the distance to the respective surface in relation to. It is preferred that each sensor remains a fixed distance away from the glass sheet as the sensor follows the respective path. When this is the case, the separation of the sensors 217, 219 remains substantially the same.

FIG. 9 shows a plan view of a portion 300 of a typical obscuration band on a flat windscreen blank. The obscuration band comprises an opaque region 301 and a fade out region 302. The opaque region consists of a black ink 303 deposited on the upper major surface 304 of the blank. The fade out region 302 comprises many circular dots 305 deposited on the upper major surface 304 of the blank. The thickness of the wet ink along a scan line in the direction of arrow 307 may be determined using an apparatus as described with reference to FIGS. 3, 5a and 6.

The present invention may be used to measure the thickness of a wet ink band that extends around the periphery of an automotive glazing. A typical vehicle windscreen blank is a sheet of float glass that is flat, has a trapezoidal outline and has typically major dimensions of 2 m by 1 m. An obscuration band typically extends from the periphery of the blank to about 200 mm inboard thereof. The inboard edge of the obscuration band is typically an array of dots so that the appearance of the obscuration band does not have an abrupt edge.

FIG. 10 shows the thickness plot of the wet ink obscuration band shown in FIG. 9 along the scan line 307 determined using an apparatus as described with reference to FIG. 3, 5a or 6.

Axis 308 represents the distance from the periphery of the blank. Axis 310 represents the distance of the upper sensor from the first incident surface, which is glass or wet ink The region 312 represents measurements of the thickness of the wet ink layer in opaque region 301. The region 314 represents measurements of the thickness variation in the fade out region 302.

Line 316 represents the distance measurement from the upper sensor to the glass surface without wet ink thereon. Line 318 represents the distance from the upper sensor to the wet ink layer in the opaque region. The thickness of the wet ink layer can be determined by difference between lines 318 and 316.

Depending upon the type of wet ink being measured, which may be ink used for an obscuration band, or conductive ink such as ink used for silver busbars, the details of the sensor may be changed accordingly. It may be necessary to use a sensor having a higher spatial resolution for silver inks This means the measuring beam has a smaller measurement region.

Confocal chromatic displacement sensors are more effective for measuring specular reflection, but certain cured inks have a diffusely scattering surface making measurement more difficult. In such circumstances, it may be necessary to scan at a lower scan rate.

Typically the scan across a 150 mm wide wet ink band takes less than 15 seconds. A scan rate of 10 mm per second or more is achievable. Higher scan rates may be used when the reflected signal is high. When the ink is deposited in the form of a pattern, such as an array of dots of the type found in the internal edges of an obscuration band, as shown in the fade out region 302 in FIG. 9, a lower scan rate allows a more detailed measurement to be made.

Suitably the wet ink thickness measurement is determined with an accuracy of ±1.5 μm or better.

The apparatus may be used in conjunction with an ink application device to control the amount of ink applied to the automotive glazing (or subsequent automotive glazings), thereby providing a more controllable print schedule. Typical ink application devices include a screen printing apparatus, an ink jet printing head and a spray.

The method may be used to produce a map of the entire ink layer on a surface of automotive glazing. This may be done by scanning the glazing in a raster manner to scan the entire glazing surface. More than one pair of sensors may be used to speed up such a measurement.

1. A method for determining the thickness of a film on a substrate, the substrate having a substantially constant thickness and having a first major surface and an opposed second major surface, wherein the film covers a portion of the first major surface, the method comprising the steps of
positioning a first sensor relative to the substrate, arranged to direct a first measuring beam onto the first major surface of the substrate;
positioning a second sensor relative to the substrate, arranged to direct a second measuring beam onto the second major surface of the substrate;
a first measurement step and a second measurement step,
the first measurement step comprising
using the first measuring beam to determine the distance from a first reference point to a portion of the first major surface of the substrate that is not covered with the film, and
using the second measuring beam to determine the distance from a second reference point to a portion of the second major surface of the substrate that is not covered with film;
and the second measurement step comprising
using the first measuring beam to determine the distance from the first reference point to the film, and using the second measuring beam to determine the distance from the second reference point to a portion of the second major surface of the substrate that is not covered with film.

2. A method according to claim 1, wherein during the first measurement step, the first sensor is opposite the second sensor.

3. A method according to claim 2, wherein the first measuring beam is in registration with the second measuring beam or wherein the first measuring beam is laterally displaced relative to the second measurement beam.

4. A method according to claim 1, wherein during the second measurement step, the second sensor is opposite the first sensor.

5. A method according to claim 4, wherein the first measuring beam is in registration with the second measuring beam or wherein the first measuring beam is laterally displaced with respect to the second measuring beam.

6. A method according to claim 1, wherein the first measuring beam has a different polarization to the second measuring beam.

7. A method according to claim 6, wherein the first measuring beam and the second measuring beam are orthogonally polarised.

8. A method according to claim 1, wherein the first sensor scans across the first major surface.

9. A method according to claim 1, wherein the second sensor scans across the second major surface.

10. A method according to claim 1, wherein the first sensor and the second sensor scan the substrate in registration.

11. A method according to claim 1, wherein the first measuring beam and/or the second measuring beam is polychromatic.

12. A method according to claim 1, wherein the first and/or second sensor is a chromatic displacement sensor, preferably a confocal chromatic displacement sensor.

13. A method according to claim 1, wherein the first reference point is associated with the first sensor.

14. A method according to claim 1, wherein the second reference point is associated with the second sensor.

15. A method according to claim 1, wherein the separation of the first sensor relative to the second sensor is the same, or substantially the same during the first measurement step and the second measurement step.

16. A method according to claim 1, wherein the first sensor is in mechanical communication with the second sensor.

17. A method according to claim 1, wherein the film comprises an ink, preferably a wet ink.

18. A method according to claim 1, wherein the substrate is a glass sheet.

19. A method according to claim 1, wherein the substrate is substantially flat.

20. A method according to claim 1, wherein the substrate is an automotive glazing.

21. A method of applying an ink to an automotive glazing pane comprising the steps of arranging an ink application device relative to a major surface of the glazing pane; applying ink to a portion of the major surface of the glazing pane; determining the thickness of the ink using a method according to claim 1; and using the thickness of the ink so determined as a control parameter to control the amount of ink subsequently applied to the glazing pane or a subsequent glazing pane.

22. Apparatus for applying ink to an automotive glazing pane comprising an ink application device for applying ink to a surface of the glazing pane; a support for the glazing pane; a first chromatic displacement sensor opposite a second chromatic displacement sensor, sufficiently spaced to accommodate the pane thickness; means for moving the glazing pane relative to the first chromatic displacement sensor; and control means in electrical communication with the ink application device and the first and/or second chromatic displacement sensors, configured to control the amount of ink applied to the surface of the glazing pane.
